(19) United States
(12) Patent Application Publication
(10) Pub. No.: US 2013/0086021 A1
(43) Pub. Date: Apr. 4, 2013

(54) APPARATUS AND METHOD FOR CONTROLLING DATA ACCESS

(71) Applicants: Takeo Iizuka, Nagoya (JP); Kenichi Shimazaki, Yokohama (JP); Takaaki Nakazawa, Nagoya (JP); Saeko Nakamura, Ichinomiya (JP)

(72) Inventors: Takeo Iizuka, Nagoya (JP); Kenichi Shimazaki, Yokohama (JP); Takaaki Nakazawa, Nagoya (JP); Saeko Nakamura, Ichinomiya (JP)

(73) Assignee: FUJITSU LIMITED, Kawasaki-shi (JP)

(21) Appl. No.: 13/611,066

(22) Filed: Sep. 12, 2012

(30) Foreign Application Priority Data
Sep. 30, 2011 (JP) 2011-218709

(51) Int. Cl. G06F 17/30

(52) U.S. Cl. 707/705; 707/E17.005

(57) ABSTRACT

A computer includes first and second storage devices where the first storage device stores first and second data and the second storage device stores the first data. The computer performs, on the first storage device, first access processing responsive to access requests to both of the first and second data. The computer performs, on the second storage device, a second access processing responsive to an access request to the first data, upon receiving an access request to the first data after performing the first access processing.

### CROSS-REFERENCE TO RELATED APPLICATION

This application is based upon and claims the benefit of priority of the prior Japanese Patent Application No. 2011-218709, filed on Sep. 30, 2011, the entire contents of which are incorporated herein by reference.

### FIELD

The embodiments discussed herein are related to an apparatus and method for controlling data access.

### BACKGROUND

A conventional technology is available to visualize service quality of operations provided by an information and communication technology (ICT) system and to monitor and analyze performance data collected from servers that are targets to be monitored in a system.

The performance data of each server is periodically collected by an agent incorporated into the server. The agent-collected performance data is sent to, for example, a manger of a management server that manages performance data in a centralized manner, and is then stored in a performance database. When a load to the performance database becomes high due to, for example, an increase in the number of servers to be monitored, scale-out for increasing the number of performance databases and scale-up for improving the processing performance of the management server may be performed.

With a related prior technology, for example, when performance information is collected from an element that is a target to be monitored and is included in a storage network, a target range or an extent for which the subsequent performance information collection is to be performed is automatically adjusted, as needed basis, based on the collected performance information. With another technology in which performance types or units to be managed are handled as elements, a correlation model is created based on a correlation of a time-series change in performance information related to a first element and a time-series change in performance information related to a second element, and the performance information about the second element is predicted from the performance information about the first element.

Japanese Laid-open Patent Publication No. 2005-157933 and Japanese Laid-open Patent Publication No. 2009-199534 are examples of related art.

### SUMMARY

According to an aspect of the invention, a computer includes first and second storage devices where the first storage device stores first and second data and the second storage device stores the first data. The computer performs, on the first storage device, first access processing responsive to access requests to both of the first and second data. The computer performs, on the second storage device, a second access processing responsive to an access request to the first data, upon receiving an access request to the first data after performing the first access processing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are schematic diagrams illustrating an example of a data control method, according to a first embodiment;

FIG. 2 is a diagram illustrating an example of a system configuration of a performance management system, according to a second embodiment;

FIG. 3 is a diagram illustrating an example of a hardware configuration of a data access apparatus, according to a second embodiment;

FIG. 4 is a diagram illustrating an example of contents stored in a routing table, according to an embodiment;

FIG. 5 is a diagram illustrating an example of a functional configuration of a data access control apparatus, according to a second embodiment;

FIG. 6 is a diagram illustrating an example of contents stored in a response management table, according to an embodiment;

FIG. 7 is a diagram illustrating an example of updating contents stored in a routing, table, according to an embodiment;

FIG. 8 is a diagram illustrating an example of contents stored in a concurrent reference count management table, according to an embodiment;

FIG. 9 is a diagram illustrating an example of contents stored in a concurrent reference ratio management table, according to an embodiment;

FIG. 10 is a schematic diagram illustrating an example of changing a storage destination database corresponding to an agent, according to an embodiment;

FIG. 11 is a diagram illustrating an example of an operational flowchart for data control processing executed by a data access control apparatus, according to a second embodiment;

FIG. 12 is a diagram illustrating an example of an operational flowchart for access status update processing, according to an embodiment;

FIG. 13 is a diagram illustrating an example of an operational flowchart for concurrent reference ratio calculation processing, according to an embodiment;

FIG. 14 is a diagram illustrating an example of an operational flowchart for group selection processing, according to an embodiment;

FIG. 15 is a diagram illustrating an example of an operational flowchart for routing processing, according to an embodiment; and

FIG. 16 is a diagram illustrating an example of a configuration of a performance management system, according to a third embodiment.

### DESCRIPTION OF EMBODIMENTS

However, the prior technology is problematic in that when users' reference requests and accesses are concentrated on a particular one of databases storing performance data collected from targets to be monitored, a response time taken to respond to the users' reference requests is increased.

### First Embodiment

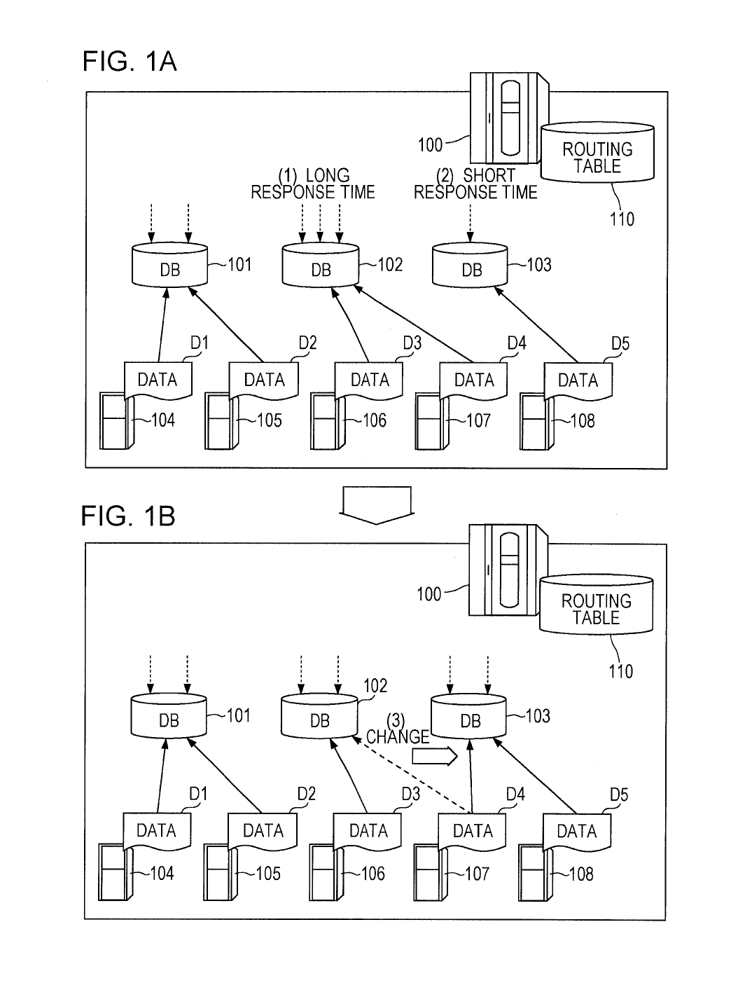

FIGS. 1A and 1B are schematic diagrams illustrating an example of a data control method, according to a first embodiment. In FIGS. 1A and 1B, the data access apparatus 100 is a computer that is able to access a routing table 110 and to distribute data that is to be stored in databases.

The routing table 110 is a table used to set databases in which data characterizing the states of targets to be monitored is stored. Hereinafter, a target to be monitored will be also expressed as “a monitoring target”, and data that characterizes the state of a monitoring target will be also expressed as “target-status data”. Monitoring targets include, for example, hardware, software, and documents that are provided in a system.

Further, for example, the monitoring targets may include system components such as web servers, application servers, database servers, virtual servers, storage units, and network units. The monitoring targets may be resources of each system component, such as a central processing unit (CPU), memories, or disks. The monitoring targets may be software installed in each system component, such as an operating system (OS), middleware, or applications.

Target-status data (data that characterizes the state of a monitoring target) is, for example, information that indicates the usage status, operating status, and traffic status of the monitoring target, which change with time. The target-status data is used to, for example, monitor, analyze, diagnose, and evaluate the performance of the entire system.

Target-status data is regularly or irregularly collected and is written into a writing-destination database that is identified by identification information set in the routing table 110. The target-status data is read out from the writing-destination database whose identification information is set in the routing table 110, in response to a reference request from a user. That is, as access processing responsive to an access request to target-status data, the target-status data is read out from a writing-destination database.

In FIGS. 1A and 1B, the databases 101 to 103 store target-status data that are periodically collected, and the servers 104 to 108 are monitoring targets. The data items D1 to D5 are pieces of target-status data that characterize the states of the servers 104 to 108, respectively.

When target-status data that is frequently referenced by users is stored only in a particular database, accesses may be concentrated on the particular database. In this case, a response time of the database to a reference request from a user may be increased, and the quality of service to the user may be lowered.

Accordingly, in a first embodiment, when accesses due to reference requests from users are concentrated on a particular database among a group of databases that store target-status data periodically collected from monitoring targets, a writing-destination of target-status data that is currently written into the particular database is changed from the particular database to another database. This may suppress increase in a response time of the database to reference requests from the users and also prevent the quality of service to the users from being lowered.

An example of a data control processing procedure executed by the data access apparatus 100 according to a first embodiment will be described. In the routing table 110, the database 101 is set as a writing-destination database into which the data items D1 and D2 are to be written, the database 102 is set as a writing-destination database into which the data items D3 and D4 are to be written, and the database 103 is set as a writing-destination database into which the data D5 is to be written.

In procedure (1), the data access apparatus 100 detects, from among the databases 101 to 103, a first database a response-time index value of which is greater than or equal to a first threshold value where the response-time index value indicates the length of a response time taken to respond to a reference request, or a data-read request. The response-time index value of a database represents the response performance of the database for a reference request, or data-read request.

For example, the longer the response time taken to respond to a data-read request is, that is, the lower the response performance for the data-read request is, the larger the response-time index value of each database is. An example of the response-time index value is the average of response times that have been actually measured for data-read requests for reading target-status data stored in the database.

A first threshold value may be set so that, for example, the service quality for users fails to be maintained when the response-time index value becomes equal to or greater than the first threshold value. This allows the data access apparatus 100 to detect a first database that has a response-time index value equal to or greater than the first threshold value and thereby has low response performance for a data-read request.

In the example of FIGS. 1A and 1B, since accesses caused by reference requests (data-read requests) from users are concentrated on the database 102 (indicated by the downward arrows in FIG. 1A), response times of the database 102 to the data reference requests are increased. As a result, the database 102 is detected as a first database (having low response performance) from among the databases 101 to 103.

In procedure (2), the data access apparatus 100 detects a second database other than the first database from among the databases 101 to 103. For example, the data access apparatus 100 may detect, from among the databases 101 to 103, a second database the response-time index value of which is smaller than a second threshold value.

The second threshold value is a value that is smaller than at least the first threshold value. The second threshold value is set so that, for example, it is determined that a response time for a data-read request is short and thereby response performance for the data-read request is high when the response-time index value falls below the second threshold value. In the example in FIG. 1A, the database 103 is detected as a second database from among the databases 101 to 103.

In procedure (3), the data access apparatus 100 changes a write-destination of target-status data that characterizes a state of at least one of monitoring-targets for which the first database is currently set as a writing-destination of the target-status data in the routing table 110, from the first database to the second database.

That is, the data access apparatus 100 changes a writing-destination of target-status data that is currently written into the first database on which accesses caused by reference requests from users are concentrated, from the first database to a second database that has higher response performance than the first database. In the example in FIG. 1B, although the database 102 has been set as a writing-destination of the data items D3 and D4, the writing-destination of the data D4 is changed to the database 103.

As described above, the data access apparatus 100 in the first embodiment may change a writing-destination of target-status data for which the first database has been set as the write-destination, from the first database to the second database. As a result, the target-status data that has been periodically collected and has been written into the first database will be written into the second database, thereby suppressing increase in a response time of the first database on which accesses caused by reference requests from users are concentrated.

When a second database the response-time index value of which is smaller than the second threshold is detected as a new database into which the target-status data is to be written, write-destinations of the target-status data may be dispersed so that accesses caused by reference requests from users are leveled among the databases. Accordingly, unevenness in the number of reference requests per one database may be suppressed and the database resources may be efficiently used.

Although the response-time index value described above is defined such that the longer a response time taken to respond to a data-read request is, that is, the lower response performance for a data-read request is, the larger the response-time index value is, the definition of the response-time index value is not limited to this. For example, the response-time index value may be defined such that the shorter a response time taken to respond to a data-read request is, that is, the higher response performance for a data-read request is, the larger the response-time index value is.

In this case, the first threshold value is set so that, for example, the service quality for users fails to be maintained when the response-time index value falls below the first threshold value. In procedure (1) above, the data access apparatus 100 may detect, as the first database, a database that has a response-time index value smaller than the first threshold value, from among the databases 101 to 103.

### Second Embodiment

A case in which a data access apparatus 100 according to a second embodiment is applied to a performance management system will be described below. The performance management system supports optimization of service quality provided by an ICT system, for example, by collecting, storing, and providing data of constituent components in the ICT system. The same elements as in the first embodiment are denoted by the same reference numerals, and descriptions thereof will be omitted.

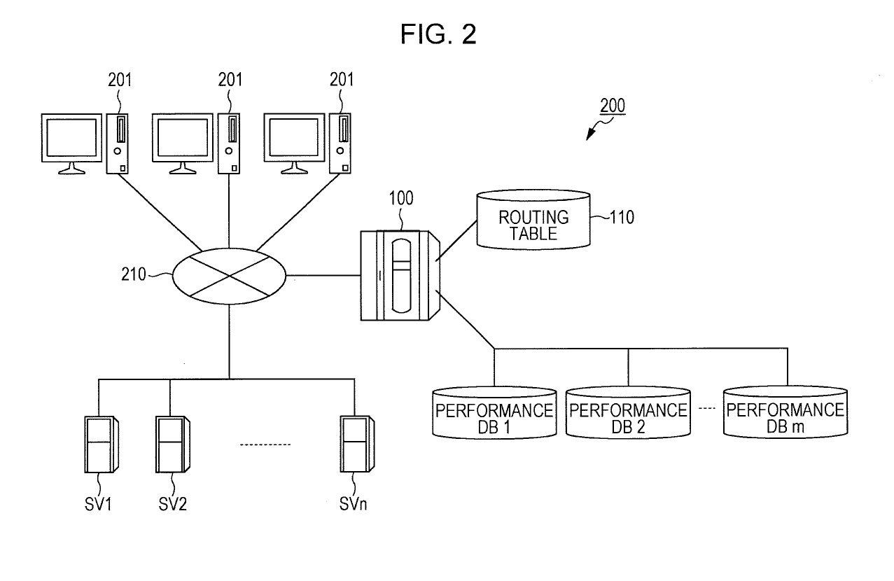

FIG. 2 is a diagram illustrating an example of a system configuration of a performance management system, according to a second embodiment. The performance management system 200 in FIG. 2 includes a data access controller 100, servers SV1 to SVn where n is a natural number not smaller than 2, and a plurality of client terminals 201 (three client terminals are depicted in the example of FIG. 2). The data access apparatus 100, the servers SV1 to SVn, and the plurality of client terminals 201 in the performance management system 200 are interconnected via a network 210 that is a wired or wireless network. Examples of the network 210 include the Internet, a local area network (LAN), and a wide area network (WAN).

The data access apparatus 100 may access performance databases 1 to m where m is a natural number not smaller than 2, and may periodically collect performance data of the servers SV1 to SVn. The performance databases 1 to m store the performance data of the servers SV1 to SVn. The servers SV1 to SVn are monitoring targets (targets to be monitored).

Performance data is target-status data that characterizes the states of monitoring targets, for example, the servers SV1 to SVn. For example, the performance data represents the usage ratios of the CPUs, memories, and disks in the servers SV1 to SVn, and represents the operating rates of the middleware and applications installed in the servers SV1 to SVn.

For example, the data access apparatus 100 receives performance data, which are collected periodically (for example, at one-minute intervals) by agents installed in the servers SV1 to SVn, from the severs SV1 to SVn. Accordingly, the performance data of the servers SV1 to SVn may be periodically collected.

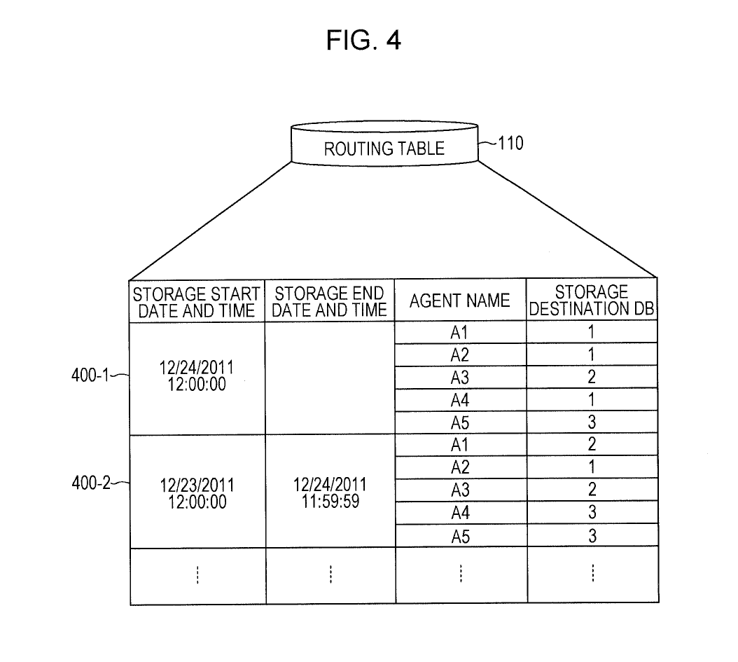

The data access apparatus 100 may also write, into the performance databases 1 to m, the performance data collected from the servers SV1 to SVn. For example, the data access apparatus 100 writes the performance data collected from the servers SV1 to SVn into performance databases whose identification information is set in the routing table 110 as writing-destinations of the performance data. The contents stored in the routing table 110 will be described later with reference to FIG. 4.

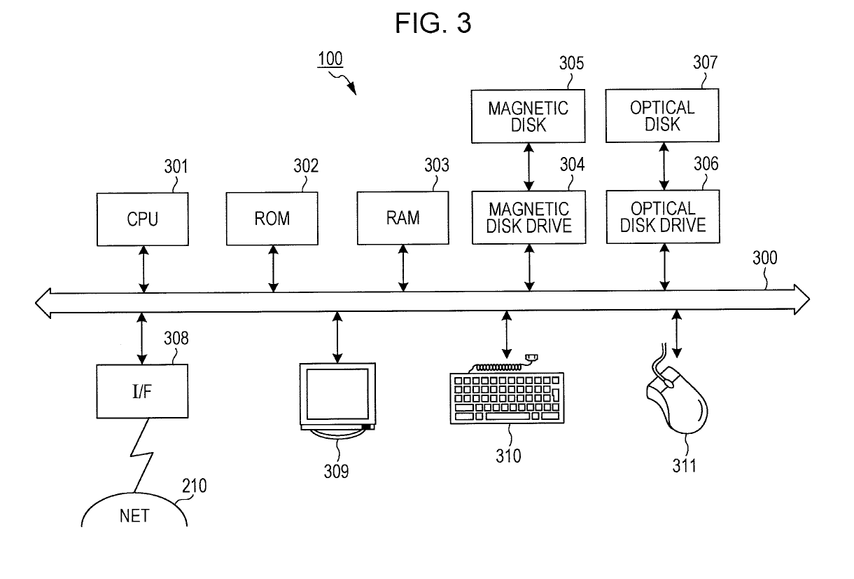

Further, the data access apparatus 100 may be configured to accept reference requests for the performance data from the client terminals 201 and to process them. A reference request is a request to read out one or more performance data items to be referenced by a user. Each reference request includes, for example, information identifying the requested performance data. Information on the accepted reference requests is stored in a storage medium, such as a random-access memory (RAM) 303, a magnetic disk 305, or an optical disk 307, of the data access apparatus 100 depicted in FIG. 3 which will be described later.

For example, the data access apparatus 100 references routing table 110 and reads out the performance data identified by the accepted reference request, from the performance database into which the performance data has been written. The data access apparatus 100 then sends the read-out performance data to the client terminal 201 that has issued the reference request.

The data access apparatus 100 may also measure a response time taken to respond to a reference request. An example of this response time is a time taken from when a request to read out performance data is sent to the performance database until the requested performance data is returned. Hereinafter, a response time taken to respond to a reference request will be also expressed as “a reference response time”.

The reference response time is measured each time a reference request is received, for example, from a client terminal 201. Measurement results are stored in a storage medium, such as the RAM 303, the magnetic disk 305, or the optical disk 307, of the data access apparatus 100 in FIG. 3 which will be described later.

The servers SV1 to SVn, which are monitoring targets, may be, for example, web servers, application servers, database servers, and other computers in the ICT system. The servers SV1 to SVn each include an agent (software) that periodically collects performance data of the each server.

The servers SV1 to SVn may be configured to send the performance data collected by the agents to the data access apparatus 100. For example, each time performance data is collected, each of the servers SV1 to SVn sends the performance data to the data access apparatus 100. As a result, the performance data of the servers SV1 to SVn are periodically collected in the data access apparatus 100.

The client terminal 201 is a computer used by a user and displays, on a display unit, the performance data of the servers SV1 to SVn which have been requested by the user. Users may be, for example, managers of systems implemented using the servers SV1 to SVn.

For example, a client terminal 201 first accepts a reference request when a user manipulates a client terminal 201 to make a reference request for referencing performance data. The client terminal 201 then sends the accepted reference request to the data access apparatus 100. Thereafter, the client terminal 201 receives performance data from the data access apparatus 100 and displays the received performance data on the display unit. Thus, the user may reference the performance data of the servers SV1 to SVn, and the performance data is utilized, for example, to locate the cause of deteriorated service quality.

In the description below, arbitrary one of the servers SV1 to SVn will be expressed as “a server SVi” (i=1, 2, . . . , n). Agents installed in servers SV1 to SVn will be respectively expressed as “agents A1 to An”. Arbitrary one of the agents A1 to An will be expressed as “an agent Ai”. Further, arbitrary one of the performance databases 1 to m will be expressed as “a performance database j” (j=1, 2, . . . m).

(Example of a Hardware Configuration of a Data Access Apparatus 100)

FIG. 3 is a diagram illustrating an example of a hardware configuration of a data access apparatus, according to a second embodiment. In FIG. 3, the data access apparatus 100 may be configured to include a CPU 301, a read-only memory (ROM) 302, a magnetic disk drive 304, the RAM 303, the magnetic disk 305, an optical disk drive 306, the optical disk 307, an interface 308, a display unit 309, a keyboard 310, and a mouse 311. These components are interconnected via a bus 300.

The CPU 301 controls the entire data access apparatus 100. The ROM 302 prestores a boot program and other programs. The RAM 303 is used as a work area of the CPU 301. The magnetic disk drive 304 controls the reading and writing of data from and to the magnetic disk 305 under control of the CPU 301. The magnetic disk 305 stores data written under control of the magnetic disk drive 304.

The optical disk drive 306 controls the reading and writing of data from and to the optical disk 307 under control of the CPU 301. The optical disk 307 stores data written under control of the optical disk drive 306. The data stored on the optical disk 307 is read by computers.

The interface 308 is connected to the network 210 via a communication line and to other computers through the network 210. The interface 308 serves as an interface between the network 210 and the inside of the data access apparatus 100, and controls input and output of data from and to other computers. Examples of the interface 308 include a modem and a LAN adaptor.

The display unit 309 displays a cursor, icon, a tool box, and data such as text, images, and functional information. Examples of the display unit 309 include a cathode-ray tube (CRT), a thin-film transistor (TFT) liquid crystal display unit, and a plasma display unit.

The keyboard 310 is provided with keys used to input letters, numerals, commands, and the like, and inputs data. The keyboard 310 may be a touch-panel input pad or numeric keypad. The mouse 311 is used to, for example, move the cursor, select a range, move a window, and change a size of the window. The mouse 311 may be a trackball, a joystick, or another pointing device, that has similar functions.

The data access apparatus 100 may also be configured by excluding the optical disk drive 306, optical disk 307, display unit 309, keyboard 310, mouse 311 and the like from the components described above. The servers SV1 to SVn and the client terminals 201 in FIG. 2 may also be implemented with a hardware configuration similar to that of the data access apparatus 100 described above.

(Contents Stored in a Routing Table 110)

Next, contents stored in a routing table 110 will be described using an example in which the number of servers SV1 to SVn is set at five (n=5) and the number of performance databases 1 to m is set at three (m=3). The routing table 110 is implemented, for example, using a storage medium such as the RAM 303, magnetic disk 305, or optical disk 307, that are depicted in FIG. 3.

FIG. 4 is a diagram illustrating an example of contents stored in a routing table, according to an embodiment. In FIG. 4, the routing table 110 includes a storage start date and time field, a storage end date and time field, an agent name field, and a storage destination database field. Routing information (such as routing information items 400-1 and 400-2) is stored in these fields.

The storage start date and time field stores the start date and time (month/date/year hours:minutes:seconds) of a time period during which performance data on a sever SVi (a monitoring target) is being stored in a performance database j (a writing destination). The storage end date and time field indicates the end date and time (month/date/year hours:minutes:seconds) of the time period during which performance data on the sever SVi is being stored in the performance database j.

The agent name field stores an identifier identifying an agent Ai installed in a server SVi where the identifier also identifies the server SVi serving as a monitoring target. The storage destination database field stores an identifier identifying the performance database j (a writing destination database) into which performance data on the server SVi (a monitoring target) is to be written.

For example, routing information 400-1 indicates storage destination databases in which the performance data of the servers SV1 to SV5 that have been collected by the respective agents A1 to A5 after the storage start date and time are being stored. For example, the performance database 1 is set as the storage destination database that stores SV1's performance data collected by the agent A1. Here, since the routing information 400-1 is the most recent routing information, no storage end date and time is set in the routing information 400-1 (the relevant field is set at blank).

The routing information 400-2 indicates storage destination databases in which the performance data of the servers SV1 to SV5 that have been collected by the respective agents A1 to A5 during a time period from the storage start date and time to the storage end date and time are being stored. For example, the performance database 2 is set as the storage destination database that stores SV1's performance data collected by the agent A1.

When writing the periodically collected performance data, the data access apparatus 100 references the routing table 110 and identifies a performance database j to be used as a writing destination database into which the collected performance data is to be written. For example, the data access apparatus 100 identifies a storage destination database corresponding to the agent name of an agent Ai installed in a server SVi, as a performance database j into which the performance data collected from the server SVi is to be written.

The agent name of an agent Ai installed in a server SVi may be included in, for example, the performance data collected from the sever SVi or may be identified from information that indicates correspondence between the server SVi and the agent Ai.

When receiving a reference request from a client terminal 201, the data access apparatus 100 references the routing table 110 and identifies a performance database j into which the requested performance data is to be written. In the reference request, for example, a structured query language (SQL) statement including a date and time (or a time period) and an agent name may be coded for each requested performance data.

For example, the data access apparatus 100 first identifies, in the routing table 110, routing information of which the time period from the storage start date and time to the storage end date and time contains the date and time stored in the reference request. The data access apparatus 100 then references the identified routing information and identifies a storage destination database corresponding to the agent name included in the reference request. Finally, the data access apparatus 100 reads out the requested performance data from the identified storage destination database.

(Example of a Functional Configuration of a Data Access Apparatus 100)

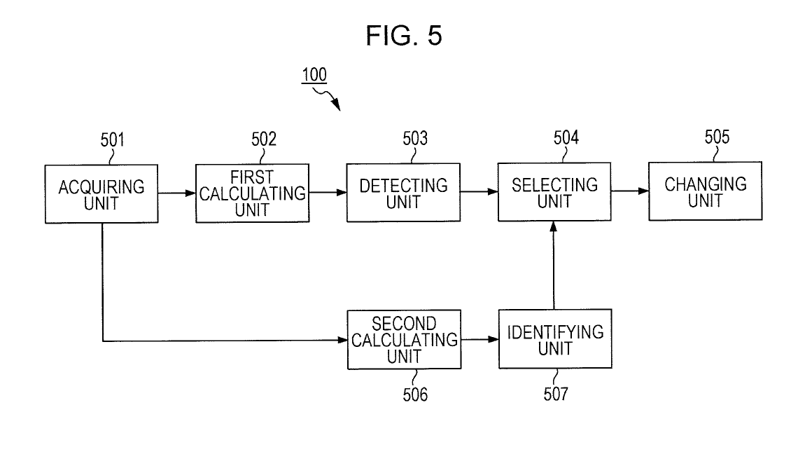

FIG. 5 is a diagram illustrating an example of a functional configuration of a data access control apparatus, according to a second embodiment. In FIG. 5, the data access control apparatus 100 includes an acquiring unit 501, a first calculating unit 502, a detecting unit 503, a selecting unit 504, a changing unit 505, a second calculating unit 506, and an identifying unit 507. These units (acquiring unit 501 to identifying unit 507) achieve their functions, for example, by causing the CPU 301 to execute programs stored in storage media such as the ROM 302, RAM 303, magnetic disk 305, and optical disk 307 in FIG. 3, using the interface 308. Processing results obtained from each unit are stored in the storage media such as the RAM 303, the magnetic disk 305, and the optical disk 307.

In the description below, unless otherwise noted, a server SVi serving as a monitoring target will be also expressed using the name of the corresponding agent installed in a server SVi, that is, expressed as “agent Ai”.

The acquiring unit 501 may be configured to acquire reference requests for performance data of an agent Ai. For example, the acquiring unit 501 reads out, from storage medium such as the RAM 303, the magnetic disk 305, or the optical disk 307, the reference requests that have been accepted from client terminals 201 and stored in the storage medium during a predetermined time period X.

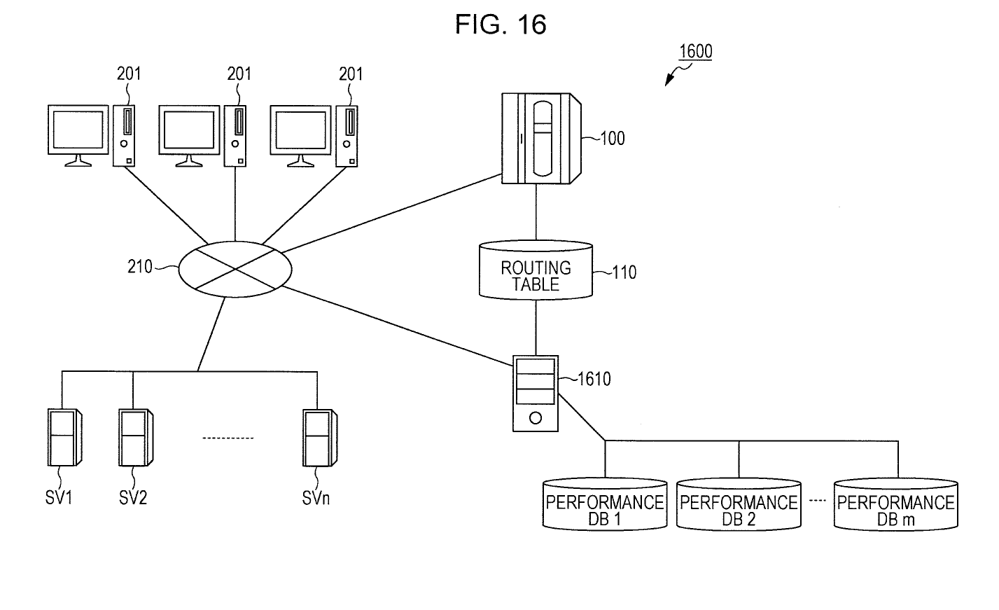

Alternatively, the acquiring unit 501 may be configured to acquire, from another computer (for example, a management server 1610 in FIG. 16 which will be described later) that accepts reference requests for performance data of an agent Ai from client terminals 201, the reference requests that have been accepted, by the another computer, from client terminals 201 during the predetermined time period X.

A predetermined time period X may be set at any value. For example, the predetermined time period X may be set at a time period that starts from a time point that is a given amount of time (for example, one hour) previous to the current time and continues to the current time or be set at a time period from the most recent storage start date and time set in the routing table 110 in FIG. 4 to the current time.

The acquiring unit 501 may be configured to acquire, for each performance database j, the measurement result of a response time taken to respond to the reference request for the performance data (hereinafter, will be also expressed as “a performance-data reference request”) of an agent Ai. For example, the acquiring unit 501 reads out the measurement results of the response time of each performance database j regarding performance-data reference requests that have been accepted from client terminals 201 during the predetermined time period X, from storage medium such as the RAM 303, the magnetic disk 305, or the optical disk 307.

Alternatively, the acquiring unit 501 may acquire, from another computer (for example, the management server 1610 in FIG. 16 which will be described later) that accepts reference requests for performance data of an agent Ai from client terminals 201, the measurement results of the response time of each performance database j regarding the performance-data reference requests that have been accepted during the predetermined time period X.

The first calculating unit 502 may be configured to calculate, for each performance database j, a response-time index value indicating the length of a response time taken to respond to a reference request for the performance data of an agent Ai. The response-time index value represents the response performance of a performance database j in response to a performance data reference request.

For example, the first calculating unit 502 may calculate the response-time index value of a performance database j, based on the measurement results of response times that have been acquired for performance database j during the predetermined time period X. Further, for example, the first calculating unit 502 may use, as the response-time index value of a performance database j, the longest response time among the measurement values of the response times of the performance database j during the predetermined time period X.

Alternatively, the first calculating unit 502 may be configured to calculate, as the response-time index value of the performance database j, the average of response times of a performance database j, based on the measurement results of response times of the performance database j during the predetermined time period X. In this case, the first calculating unit 502 may calculate the average of the response times of the performance database j, for example, based on the measurement results of the N longest response times of the performance database j during the predetermined time period X.

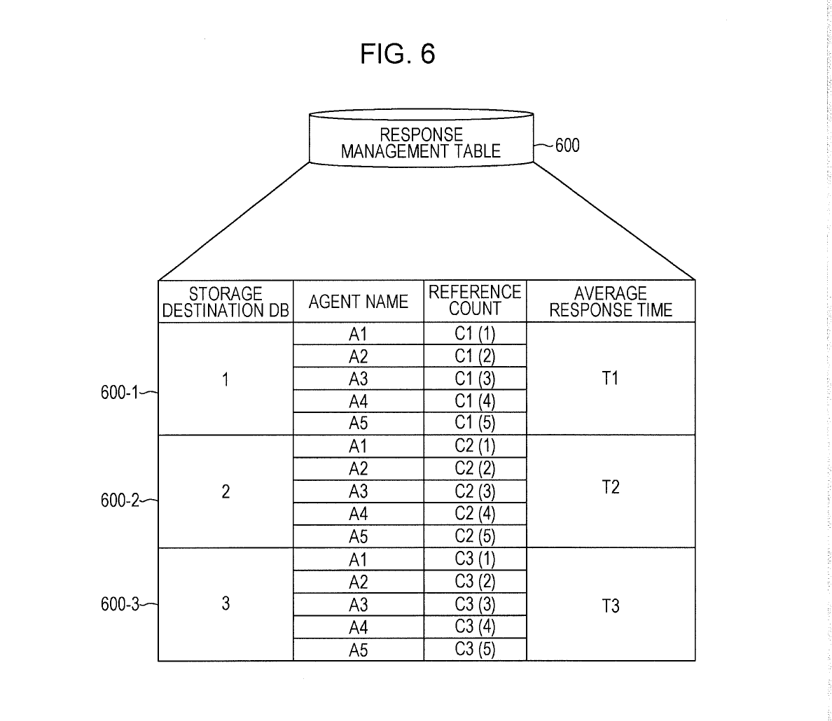

In the example described below, the average response time of a performance database j (referred to below as “an average response time Tj”) is used as an exemplary response-time index value of the performance database j. The calculated average response time Tj of the performance database j is stored, for example, in a response management table 600 in FIG. 6 which will be described later.

The first calculating unit 502 may be configured to calculate, for each performance database j, the number of references of the performance data collected by an agent Ai. For example, the first calculating unit 502 calculates, for each performance data j, the number of references of the performance data collected by an agent Ai (referred to below as “the reference count Cj(i)”) in response to reference requests accepted during the predetermined time period X.

For example, the first calculating unit 502 first selects a reference request from a set of performance data reference requests accepted during the predetermined time period X. The first calculating unit 502 then references the routing table 110 and identifies a storage destination database into which the requested performance data has been written, based on the selected reference request.

After that, the first calculating unit 502 increments, for the identified storage destination database j, the reference count Cj(i) of the agent Ai identified by the reference request. The first calculating unit 502 repeats the above processing until all performance data reference requests are selected from the set of performance data reference requests accepted during the predetermined time period X. Accordingly, the reference count Cj(i) of the agent Ai may be calculated in association with each performance database j.

The calculated reference count Cj(i) of the agent Ai is stored, for example, in the response management table 600 in FIG. 6. The response management table 600 is implemented, for example, using a storage medium such as the RAM 303, magnetic disk 305, or optical disk 307. Contents stored in the response management table 600 will be described below.

FIG. 6 is a diagram illustrating an example of contents stored in a response management table, according to an embodiment. In FIG. 6, the response management table 600 stores response management information items 600-1 to 600-3 corresponding to the respective performance databases 1 to 3, where the response management information items 600-1 to 600-3 each include a storage destination database field, an agent name field, a reference count field, and an average response time field.

The storage destination database field stores identifier identifying a performance database j. The agent name field stores identifier identifying an agent Ai installed in a server SVi to be monitored. The reference count field stores the number of times the performance data collected by the agent Ai has been referenced. The average response time field stores an average response time Tj (the unit of which is, for example, seconds) of the performance database j.

For example, the response management information 600-1 stores reference counts C1(1) to C1(5) of pieces of performance data that are, respectively, collected by the agents A1 to A5 and stored in the performance database 1. The average response time T1 of the performance database 1 is also stored in the response management information 600-1.

Referring back to FIG. 5, the detecting unit 503 may be configured to detect, from among the performance databases 1 to m, performance databases j that have an average response time Tj longer than or equal to an activation reference value α. Here, the activation reference value α is set so that when the average response time Tj becomes longer than or equal to the activation reference value α, the service quality required by users fails to be maintained.

That is, the detecting unit 503 detects a performance database j on which users' accesses have concentrated to an extent that the response time from issuing a performance-data reference request until the requested performance data is returned from the performance database j is too long to maintain the service quality for users.

For example, the detecting unit 503 references the response management table 600 in FIG. 6 and detects a performance database j the average response time Tj of which is longer than or equal to the activation reference value α. The activation reference value α is prestored in a storage medium such as the ROM 302, the RAM 303, the magnetic disk 305, or the optical disk 307.

When there exist a plurality of performance databases the average response times of which are longer than or equal to the activation reference value α, the detecting unit 503 may detect the performance database j the average response time Tj of which is longest. Accordingly, it becomes possible to detect, from among the performance databases 1 to m, a performance database j in which performance data frequently referenced by users is stored in a concentrated manner and thereby on which accesses may most concentrate.

As an example, it is assumed that the average response times T1 to T3 (in seconds) of the performance databases 1 to 3, which are set in the response management table 600, are respectively 3.5, 0.15, and 1.8, and that the activation reference value α (in seconds) is 3.0. Then, the detecting unit 503 detects, from among the performance databases 1 to 3, the performance database 1, the average response time T1 of which longer than or equal to the activation reference value α.

In the description below, a performance database j the average response time Tj of which is longer than or equal to the activation reference value α will be also expresses as “a first performance database”.

The detecting unit 503 may also be configured to detect, from among the performance databases 1 to m, a performance database j the average response time Tj of which is shorter than a suppression reference value β. Here, the suppression reference value β is a value that is at least shorter than the activation reference value α. The suppression reference value β may be set so that when, for example, the average response time Tj is shorter than the suppression reference value β, the response performance of the performance database j for performance data reference requests is determined to be superior.

That is, the detecting unit 503 detects a performance database j that assures its response time taken until the requested performance data is returned from the performance database j so that the service quality for users is adequately maintained.

For example, when the first performance database is detected, the detecting unit 503 references the response management table 600 and detects a performance database j the average response time Tj of which is shorter than the suppression reference value β. The suppression reference value β is prestored in a storage medium, such as the ROM 302, the RAM 303, the magnetic disk 305, or the optical disk 307.

As an example, it is assumed that the average response times T1 to T3 (in seconds) of the performance databases 1 to 3, which are set in the response management table 600, are respectively 3.5, 0.15, and 1.8, and that the suppression reference value β (in seconds) is 1.0. Then, the detecting unit 503 detects, from the performance databases 1 to 3, a performance database 2 the average response time T2 of which is shorter than the suppression reference value β.

When there are a plurality of performance databases the average response times Tj of which are shorter than the suppression reference value β, the detecting unit 503 may detect a performance database j the average response time Tj of which is shortest. Accordingly, it becomes possible to detect, from the performance databases 1 to m, a performance database j that has the highest response performance for reference requests from users.

In the description below, a performance database j the average response time Tj of which is shorter than the suppression reference value β will be also expressed as “a second performance database”.

The selecting unit 504 may be configured to select at least one agent Ai for which the detected first performance database has been set as a writing destination. That is, the selecting unit 504 selects, from among agents for which the first performance database has been set as a writing destination, an agent Ai for which the storage destination database is to be changed.

For example, the selecting unit 504 may select an agent Ai for which the storage destination database is to be changed, according to a frequency at which the performance data, collected by each agent Ai for which the first performance database has been set as a writing destination, is read from the first performance database. As a frequency at which performance data is read from the first performance database, for example, “a reference count” that indicates the number of times the performance data collected by an agent Ai has been referenced during the predetermined time period X may be used.

For example, the selecting unit 504 first references the most recent information in the routing table 110 and identifies an agent name for which the first performance database has been set as the storage destination database. The most recent routing information is the routing information that has the most recent storage start date and time in the routing table 110 (for example, routing information 400-1).

The selecting unit 504 then references the response management information corresponding to the first performance database in the response management table 600 and selects, from the agents for which the first performance database has been set as the storage destination database, the agent name corresponding to the largest reference count.

For example, it is assumed that the first performance database is the performance database 1. The selecting unit 504 first references the routing information 400-1 in the routing table 110 and identifies the agent names A1, A2, and A4 for which the performance database 1 has been set as the storage destination database. The selecting unit 504 then references the response management information 600-1 in the response management table 600 and selects, from among the agent names A1, A2 and A4, the agent name corresponding to the largest reference count. For example, the reference count C1(2) is assumed to have the largest value among the reference counts C1(1), C1(2), and C(4). In this case, the selecting unit 504 select the agent name A2 corresponding to the largest reference count, from among the agent names A1, A2, and A4.

Thus, the selecting unit 504 may select, as the agent Ai for which the storage destination database is to be changed, the agent corresponding to the maximum number of reference count of performance data, from among agents for which the first performance database has been set as a storage destination database.

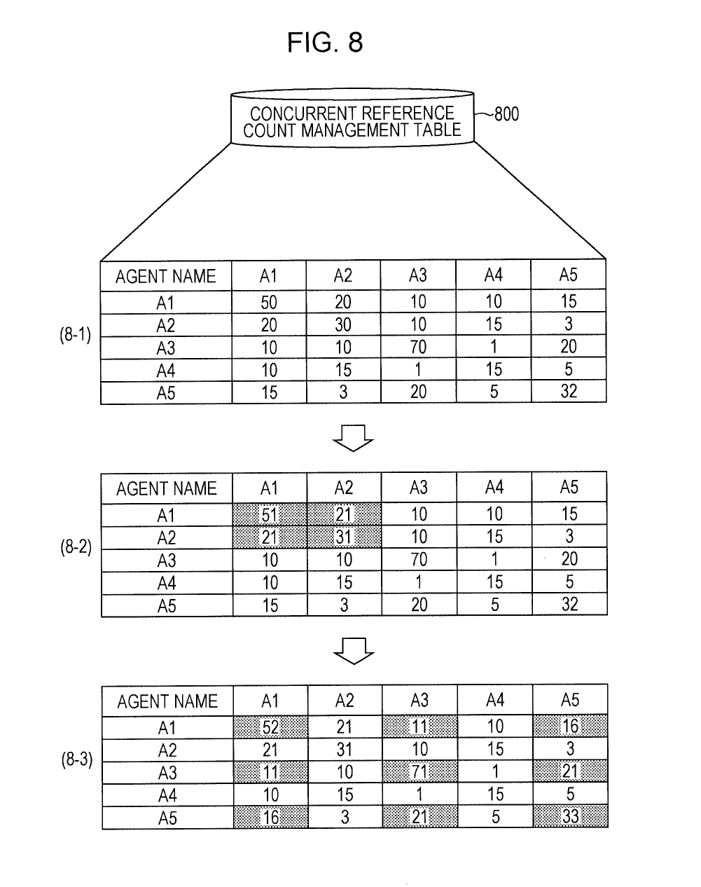

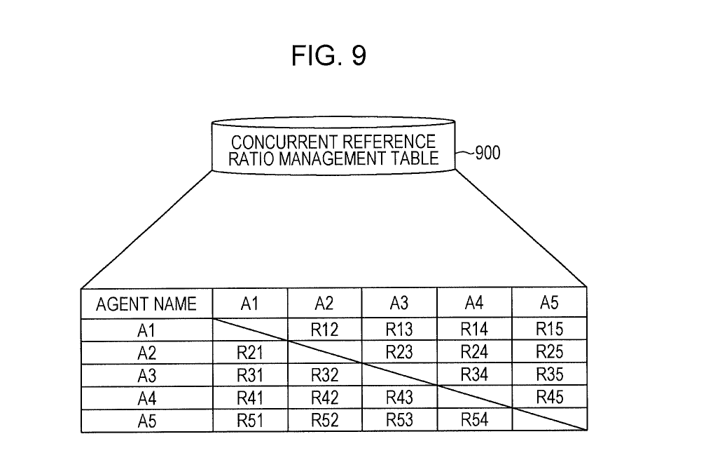

Other examples of selecting the agent Ai for which a storage destination database is to be changed, from among agents for which the first performance database has been set as a writing destination, will be described later with reference to FIGS. 8 and 9.

The changing unit 505 may be configured to change, to the detected second performance database, a writing destination into which performance data, collected by the agent Ai selected from among agents for which the first performance database has been set as a writing destination, is to be written. For example, the changing unit 505 changes a storage destination database that has been set in the routing table 110 in association with the agent Ai, from the first performance database to the second performance database. An example of updating the routing table 110 will be described below.

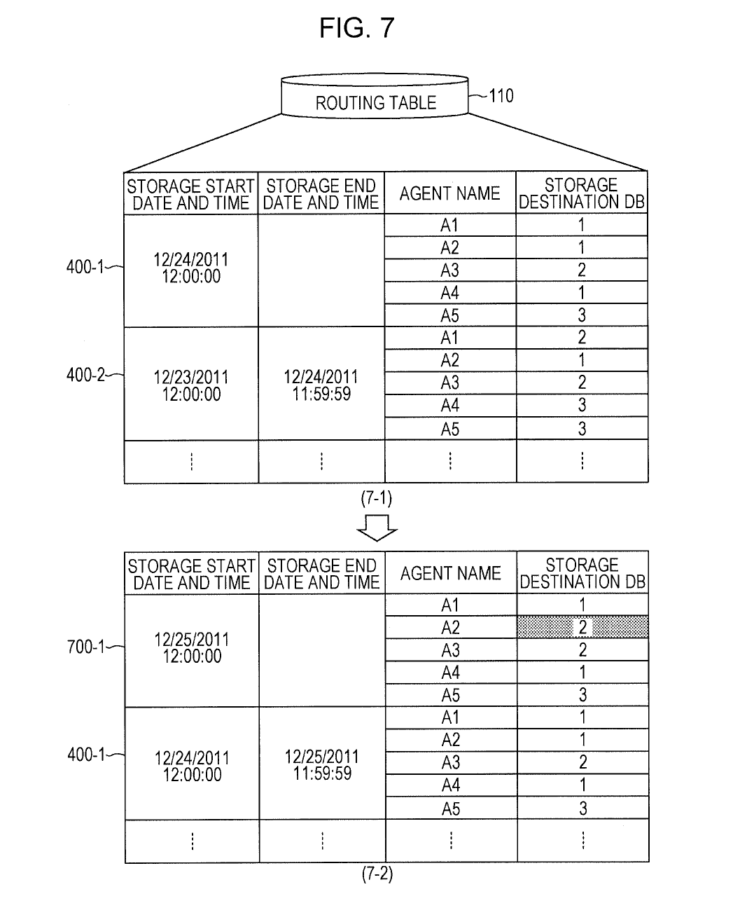

FIG. 7 is a diagram illustrating an example of updating contents stored in a routing table, according to an embodiment. In FIG. 7, denotation (7-1) indicates contents stored in the routing table 110 before the routing table 110 is updated. Here, it is assumed that the performance database 1 is a first performance database and the performance database 2 is a second performance database. It is also assumed that, out of the agents A1, A2 and A4 for which the performance database 1 has been set as the storage destination database, the agent A2 is an agent Ai for which the storage destination database is to be changed.

Denotation (7-2) in FIG. 7 illustrates contents stored in the routing table 110 after the routing table 110 has been updated. In this example, a storage destination database in which the performance data collected by the agent A2 is to be stored has been changed from the performance database 1 to the performance database 2, and then new routing information 700-1 is stored in the routing table 110.

For example, “12/25/2011 11:59:59” is first set to the storage end date and time field of the routing information 400-1 in response to the change of the storage destination database of the performance data collected by the agent A2.

Then, “12/25/2011 12:00:00” is set to the storage start date and time field of the new routing information 700-1, and “2” is set to the storage destination database field corresponding to the agent A2 for which the storage destination database has been changed. In the storage destination database field corresponding to the agents A1, A3, A4, and A5 other than the agent A2, the same information as in the routing information 400-1 is set.

As a result, performance data that has been periodically collected by the agent A2 and has been written into the performance database 1 will be written into the performance database 2 in subsequent performance data collections. Thus, it becomes possible to suppress an increase in the response time of the performance database 1 on which accesses due to reference requests from users have concentrated.

Further, by detecting, as a second performance database, the performance database 2 the average response time Tj of which is shorter than the suppression reference value β, writing destination databases (or storage destination databases) of the performance data collected by individual agents are distributed so that reference requests from users are leveled among the databases. Thus, the unevenness of the number of reference requests per performance database may be suppressed and database resources may be efficiently utilized.

(Examples of Selecting Agent Ai for which the Storage Destination Database is to be Changed)

Next, other examples of selecting an agent Ai for which the storage destination database is to be changed, from among agents for which the first performance database has been set as a writing destination, will be described. When pieces of performance data collected by a plurality of agents are frequently referenced at the same time, response performance may be improved by storing the pieces of performance data in different performance databases, respectively. This is because, for example, the pieces of performance data may be read out concurrently from the different performance databases, respectively.

Accordingly, a case will be described below in which an agent Ai for which the storage destination database is to be changed is selected so that pieces of performance data collected by a plurality of agents and frequently referenced at the same time are written into different performance databases as far as possible.

First, regarding the first performance database, the second calculating unit 506 calculates, for each pair of two mutually different agents, a frequency at which performance data collected by the each pair of different agents are referenced at the same time. For example, regarding the first performance database, the second calculating unit 506 counts, for each pair of mutually different agents, the number of times performance data collected by the each pair of mutually different agents have been referenced at the same time.

Exemplary processing to count the number of times performance data collected by the each pair of mutually different agents are referenced at the same time (this number will be referred to below as “the concurrent reference count”) will be described with reference to a concurrent reference count management table 800 in FIG. 8.

FIG. 8 is a diagram illustrating an example of contents stored in a concurrent reference count management table, according to an embodiment. The concurrent reference count management table 800 may be implemented, for example, using a storage medium, such as the RAM 303, the magnetic disk 305, or the optical disk 307. In FIG. 8, regarding the first performance database, the concurrent reference count management table 800 stores, for each pair of different mutually different agents, the concurrent reference count of performance data collected by the each pair of mutually different agents. In the initial state, each concurrent reference count in the concurrent reference count management table 800 is set at zero.

For example, the second calculating unit 506 first selects a reference request to reference performance data stored in the first performance database from among a set of performance data reference requests accepted during a predetermined time period X.

Here, it is assumed that the agent names A1 and A2 are included in the selected reference request. In this case, the second calculating unit 506 increments the value of the cell of row A1 and column A1, the value of the cell of row A1 and column A2, the value of the cell of row A2 and column A1, and the value of the cell of row A2 and column A2, in the concurrent reference count management table 800 (as illustrated in a table denoted by (8-2) in FIG. 8).

As another case, it is assumed that the agent name A1, A3, and A5 are included in the selected reference request. In this case, the second calculating unit 506 increments the value of the cell of row A1 and column A1, the value of the cell of row A1 and column A3, the value of the cell of row A1 and column A5, the value of the cell of row A3 and column A1, the value of the cell of row A3 and column A3, the value of the cell of row A3 and column A5, the value of the cell of row A5 and column A1, the value of the cell of row A5 and column A3, and the value of the cell of row A5 and column AS in the concurrent reference count management table 800 (as illustrated in a table denoted by (8-3) in FIG. 8).

When only the agent name A1 is included in the selected reference request, the second calculating unit 506 increments the value in the cell of row A1 and column A1 in the concurrent reference count management table 800.

The first calculating unit 502 repeats the processing described above until all reference requests, for referencing performance data stored in the first performance database, included in the set of performance data reference requests accepted during the predetermined time period X.

In this way, the concurrent reference count of performance data collected by each pair of mutually different agents may be obtained by incrementing the values, in the concurrent reference count management table 800, that correspond to the combinations of the agent names included in the reference requests accepted during the predetermined time period X. For example, in a table denoted by (8-3) of FIG. 8, the number of times the performance data that have been collected by the agent A1 in response to reference requests accepted during the predetermined time period X and stored in the first performance database is “52”, out of which the number of times the performance data collected by the agent A1 has been referenced at the same time that the performance data collected by the agent A2 has been referenced is “21”.

Although, in the above description, the concurrent reference count management table 800 is created only for the first performance database, the embodiment is not limited to this. For example, the concurrent reference count management table 800 may be prepared for each performance database j among the performance databases 1 to m, and each time a performance data reference request from a user is accepted, the relevant concurrent reference count management table 800 is updated.

The second calculating unit 506 references the concurrent reference count management table 800 and calculates a frequency at which the performance data collected by each pair of mutually different agents is referenced at the same time. For example, the second calculating unit 506 may obtain a frequency at which the performance data collected by the each pair of agents are referenced at the same time (hereinafter, the frequency will also be referred to as “the concurrent reference ratio”) according to the following equation:

Rpq={(Cpq×2)/(Cp+Cq)}×100 (1)

In equation (1), Rpq is the concurrent reference ratio of the performance data collected by a pair of mutually different agents Ap and Aq (p=1, 2, . . . , n, q=1, 2, . . . , n, p≠q); Cpq is the concurrent reference count of the performance data collected by the pair of mutually different agents Ap and Aq; Cp is the concurrent reference count of the performance data collected by the agent Ap; Cq is the concurrent reference count of the performance data collected by the agent Aq.

Cpq is, for example, the value of the cell of row p and column q (or row q and column p) in the concurrent reference count management table 800. Cp is, for example, the value of the cell of row p and column p in the concurrent reference count management table 800. Cq is, for example, the value of the cell of row q and column q in the concurrent reference count management table 800.

An example of obtaining the concurrent reference ratio R12 at which the performance data collected by the agent A1 and the performance data collected by the agent A2 are referenced at the same time will be described. In this example, it is assumed that in the concurrent reference count management table 800, the value of the cell of row A1 and column A1 is “50”, the value of the cell of row A1 and column A2 is “20”, the value of the cell of row A2 and column A1 is “20”, and the value of the cell of row A2 and column A2 is “30”, as illustrated in a table denoted by (8-1) of FIG. 8. Then, the concurrent reference ratio R12 at which the performance data collected by the agent A1 and the performance data collected by agent A2 are referenced at the same time becomes “50%” (R12={(20×2)/(50+30)}×100=50).

The method of calculating the concurrent reference ratio Rpq is not limited to the above calculation. For example, the second calculating unit 506 may calculate the ratio of the concurrent reference count Cpq of the performance data collected by the agents Ap and Aq to the total number of reference requests made for the first performance database, as the concurrent reference ratio Rpq.

The calculated concurrent reference ratio Rpq is stored in, for example, a concurrent reference ratio management table 900 illustrated in FIG. 9. Contents stored in the concurrent reference ratio management table 900 will be described below.

FIG. 9 is a diagram illustrating an example of contents stored in a concurrent reference ratio management table, according to an embodiment. The concurrent reference ratio management table 900 may be implemented, for example, using a storage medium, such as the RAM 303, the magnetic disk 305, or the optical disk 307. The concurrent reference ratio management table 900 in FIG. 9 stores the concurrent reference ratio of performance data, regarding the first performance database, that are collected by each pair of mutually different agents.

For example, the concurrent reference ratio R12 represents a ratio at which, when performance data collected by the agent A1 and stored in the first performance database is referenced, performance data collected by the agent A2 is also referenced at the same time. In the concurrent reference ratio management table 900, the concurrent reference ratio Rpq and concurrent reference ratio Rqp have the same value.

The identifying unit 507 identifies, from among a set of pairs each including two mutually different agents, pairs for which the concurrent reference ratio is greater than or equal to a predetermined threshold value γ. For example, the identifying unit 507 references the concurrent reference ratio management table 900 and identifies pairs for which the concurrent reference ratio is greater than or equal to the predetermined threshold value γ.

The threshold value γ is predetermined, for example, based on the number of servers SV1 to SVn or the number of performance databases 1 to m (for example, γ may be set at 50(%)). The threshold value γ may be prestored in a storage medium such as the ROM 302, the RAM 303, the magnetic disk 305, or the optical disk 307.

Here, it is assumed that the concurrent reference ratios R12, R13, and R45 in the concurrent reference ratio management table 900 are greater than or equal to the threshold value γ. In this case, a pair P1 of agents A1 and A2, a pair P2 of agents A1 and A3, and a pair P3 of agents A4 and A5, may be identified.

The selecting unit 504 selects one of the identified pairs for which the concurrent reference ratio is greater than or equal to the predetermined threshold value γ. For example, the selecting unit 504 may select a pair for which the total sum of reference counts of the performance data collected by the respective agents included in the pair is largest among the identified pairs. The reference count of the performance data collected by each agent may be identified from, for example, the response management table 600 in FIG. 6.

The selecting unit 504 then selects an agent Ai included in the selected pair. For example, the selecting unit 504 may select, from the two agents included in selected pair, an agent that collected the performance data the reference count of which is greater than the reference count of the performance data collected by the other agent.

Thus, an agent Ai for which the storage destination database is to be changed may be selected from the pair of agents for which performance data are most frequently referenced at the same time. As a result, two pieces of performance data that are collected by two agents and are frequently referenced at the same time are stored in different performance databases, thereby improving the response performance of performance databases.

Further, since an agent Ai for which the storage destination database is to be changed is selected from the pair of agents for which performance data are most frequently referenced at the same time, performance data reference requests from users may be efficiently distributed among the performance databases 1 to m.

There may be a case in which the first performance database has not been set as the storage destination database that includes the performance data collected by a pair of agents involved in the highest concurrent reference frequency. Accordingly, out of the agents A1 o An, only pairs of agents for which the first performance database has been set as the storage destination database may be subjected to the calculation of the concurrent reference ratio.

For example, the second calculating unit 506 may calculate the concurrent reference ratio of the performance data collected by the agents included in each pair for which the first performance database has been set as the storage destination database. Thus, it is possible to select, as an agent Ai for which the storage destination database is to be changed, an agent Ai included in the agent pair involved in the highest concurrent reference frequency, from among agent pairs for which the first performance database has been set as the storage destination database.

There may be another case in which the pair involved in the highest concurrent reference frequency includes an agent for which the first performance database has been set as the storage destination database and also includes another agent for which the first performance database has not been set as the storage destination database. In this case, the selecting unit 504 may select the agent for which the first performance database has been set as the storage destination database, from the two agents included in the pair.

(An Example of Processing Executed when a Plurality of Second Performance Databases are Detected)

There may be a case in which a plurality of second performance databases that have an average response time shorter than the suppression reference value β are detected. Example of processing executed in this case will be described below. The plurality of detected second performance databases will be expressed as “second performance databases $1 to $K”. An arbitrary second performance database in the second performance databases $1 to $K will be expressed as “a performance database $k (k=1, 2, . . . K)”.

The identifying unit 507 first references the concurrent reference ratio management table 900 and identifies pairs for which the concurrent reference ratio is greater than or equal to the threshold value γ, with respect to the first performance database. Here, it is assumed that concurrent reference ratios R12, R13, and R45 in the concurrent reference ratio management table 900 are greater than or equal to the threshold value γ. In this case, a pair P1 of agents A1 and A2, a pair P2 of agents A1 and A3, and a pair P3 of agents A4 and A5, are identified.

Next, the identifying unit 507 classifies the pairs for which the concurrent reference ratio is greater than or equal to the threshold value γ, to create a groups that includes a plurality of different agents. For example, the identifying unit 507 compiles pairs that include the same agent to create a group that includes a plurality of different agents.

In the case of the above pairs P1 to P3, the pairs P1 and P2 each include the same agent A1. Accordingly, the identifying unit 507 compiles the pairs P1 and P2 and creates a group G1 that includes the agents A1, A2, and A3. The identifying unit 507 also creates, from the pair P3, a group G2 including agents A4 and A5.

Created groups will be expressed as “groups G1 to GS”, and an arbitrary group in the groups G1 to GS will be expressed as “a group Gs” (s=1, 2, . . . S).

The identifying unit 507 determines whether the number of agents included in a created group Gs is greater than or equal to a threshold value δ. The threshold value δ may be, for example, beforehand stored in a storage medium such as the ROM 302, the RAM 303, the magnetic disk 305, or the optical disk 307.

When the number of agents included in the group Gs is greater than or equal to a threshold value δ, the identifying unit 507 excludes an agent from the group Gs according to a predetermined method. For example, the identifying unit 507 may reference the response management information associated with the first performance database in the response management table 600 and may exclude the agent, included in the group, that corresponds to the smallest reference count.

Thus, the number of agents in the group Gs may be restricted so that that number of agents in the group Gs is maintained below a fixed value. This prevents storage destination databases into which performance data collected by agents are to be written, from being distributed too much, and prevents the number of agents for which the first performance database has been set as the storage destination database, from being decreased.

The identifying unit 507 selects a group Gs from the created groups G1 to GS. For example, the identifying unit 507 selects, from among the groups G1 to GS, a group Gs of which a total reference count is largest among the groups G1 to GS, where the total reference count is obtained by totaling the reference counts for the agents included in the group Gs.

The total reference count for each group may be obtained, for example, by referencing the response management information associated with the first performance database stored in the response management table 600. When the first performance database is assumed to be the performance database 1, for example, the total reference count for the group G1 is the sum of the reference count C1(1) for the agent A1, the reference count C1(2) for the agent A2, and the reference count C1(3) for the agent A3. The total reference count for the group G2 is the sum of the reference count C1(4) for the agent A4 and the reference count C1(5) for the agent A5.

In the description below, agents included in the group Gs will be expressed as “agents A[1] to A[F]”, and an arbitrary agent of the agents A[1] to A[F] will be expressed as “an agent A[f]” (F is a natural number not smaller than 1 and f is 1, 2, . . . F).

The selecting unit 504 selects an arbitrary agent A[f] from among the agents A[1] to A[F] included in the group Gs. For example, the selecting unit 504 may reference the response management information associated with the first performance database stored in the response management table 600 and may select, from among the agents A[1] to A[F], the agent A[f] for which the reference count is largest.

The selecting unit 504 also selects a second performance database $k from among the second performance databases $1 to $K. For example, the selecting unit 504 may select the performance database $k that has the shortest average response time from among the second performance databases $1 to $K, by referencing the response management table 600.

The changing unit 505 changes a writing destination (a storage destination database) into which performance data collected by an agent A[f] selected from agents for which the first performance database has been set as the writing destination is to be written, to the selected second performance database $k. For example, the changing unit 505 changes a storage destination database corresponding to the agent A[f] set in the rouging information 110 to the second performance database $k.

The above processing to select the agent A[f] is repeated until, for example, all of the agents A[1] to A[F] have been selected.

The above processing executed by the selecting unit 504 to select the second performance database $k is carried out each time an agent A[f] is selected. In this case, the selecting unit 504 may select, from among the second performance databases $1 to $K, the performance database $k that has not been selected and has the shortest response time.

When all the performance databases $k included in the second performance databases $1 to $K have been already selected, the selecting unit 504 may select a performance database $k with the shortest response time again in succession. Here, an example of changing a storage destination database into which performance data collected by the agent A[f] eligible for changing is to be written will be described.

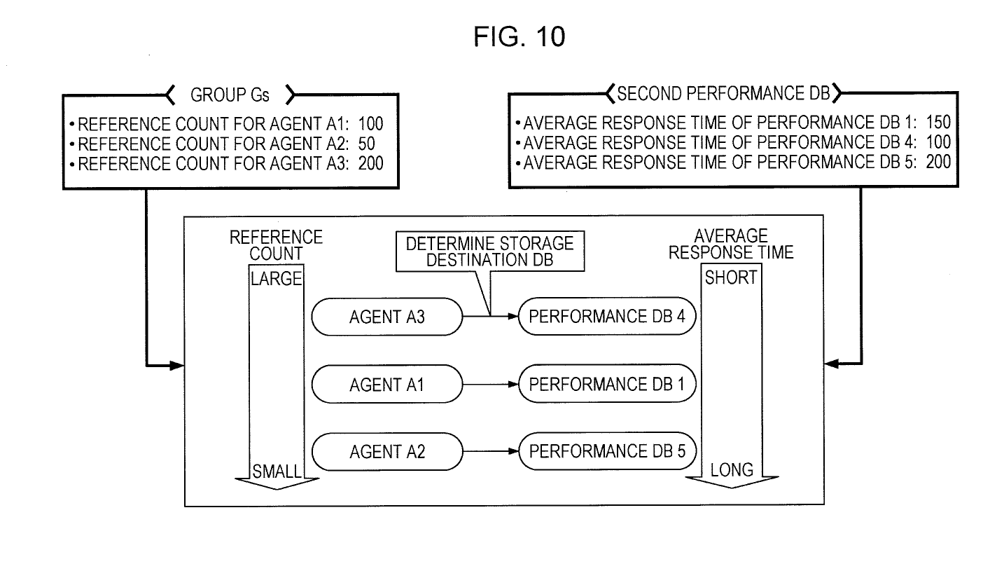

FIG. 10 is a schematic diagram illustrating an example of changing a storage destination database corresponding to an agent, according to an embodiment. In FIG. 10, it is assumed that the agents A[1] to A[F] included in the group Gs are the agents A1 to A3. The storage destination database of performance data collected by the agents A1 to A3 is assumed to be the performance database 2 serving as a first performance database.

Further, second performance databases $1 to $K are performance databases 1, 4, and 5. The average response time T1 of the performance database 1 is “150 ms”; the average response time T4 of the performance database 4 is “100 ms”; and the average response time T5 of the performance database 5 is “200 ms”.

In this case, the selecting unit 504 first selects the agent A3 for which the reference count is largest, from among the group Gs. The selecting unit 504 then selects the performance database 4 for which the average response time is shortest, from among the performance databases 1, 4, and 5. The changing unit 505 then changes a storage destination database whose identification information has been set in the routing table 110 in association with the agent A3, from the performance database 2 to the performance database 4.

The selecting unit 504 then selects the agent A1 which corresponds to the second largest reference count, from among the group Gs. Thereafter, the selecting unit 504 selects the performance database 1 which corresponds to the second shortest average response time, from among the performance databases 1, 4, and 5. Then, the changing unit 505 changes a storage destination database whose identification information has been set in the routing table 110 in association with the agent A1, from the performance database 2 to the performance database 1.

The selecting unit 504 then selects the agent A2 which corresponds to the smallest reference count, from among the group Gs. Thereafter, the selecting unit 504 selects the performance database 5 which corresponds to the longest average response time, from among the performance databases 1, 4, and 5. Then, the changing unit 505 changes a storage destination database whose identification information has been set in the routing table 110 in association with the agent A2, from the performance database 2 to the performance database 5.

As mentioned above, by selecting an agent A[f] sequentially in descending order of a reference count from among the group Gs and by changing a storage destination database to a performance database $k having the shortest average response time, performance data reference requests from users may be efficiently distributed among the performance databases 1 to m.

There may be a case in which the storage destination database into which the performance data collected by an agent A[f] included in a group Gs is to be written is not set as a first performance database. Accordingly, as described above, the second calculating unit 506 may calculate the concurrent reference ratio of the performance data collected by the agents included in each pair for which the first performance database has been set as a storage destination database.

As a target for which the storage destination database is to be changed, the selecting unit 504 may select an agent A[f] for which the first performance database has been set as the storage destination database, for example, from among a group Gs. In this case, performance databases that have been set as performance databases that store performance data collected by agents included in the group Gs may be excluded from the second performance databases $1 to $K, and the selecting unit 504 may select a second performance database $k from among the remaining performance databases.

For example, it is assumed in the example in FIG. 10 that the first performance database has been set as the storage destination database of performance data collected by the agent A1 in the group Gs including the agents A1 to A3. It is also assumed that the performance database 4 has been set as the storage destination database of performance data collected by the agent A2 and the performance database 3 has been set as the storage destination database of performance data collected by the agent A3.

In this case, the selecting unit 504 first selects the agent A1 from among the group Gs including the agents A1 to A3. The selecting unit 504 excludes the performance database 4 which has been set as the storage destination database of performance data collected by the agent A2, from the performance databases 1, 4, and 5, and selects the performance database 1 having a shorter average response time from among the remaining performance databases 1 and 5. The changing unit 505 changes the storage destination database that has been set in the routing table 110 in association with the agent A1, to the performance database 1.

(Data Control Processing Executed by the Data Access Apparatus 100)

A data control processing executed by the data access apparatus 100 according to a second embodiment will be described. Data control processing executed by the data access apparatus 100 is repeated each time, for example, a fixed time period×has elapsed (for example, every hour at the 59th minute and 59th second).

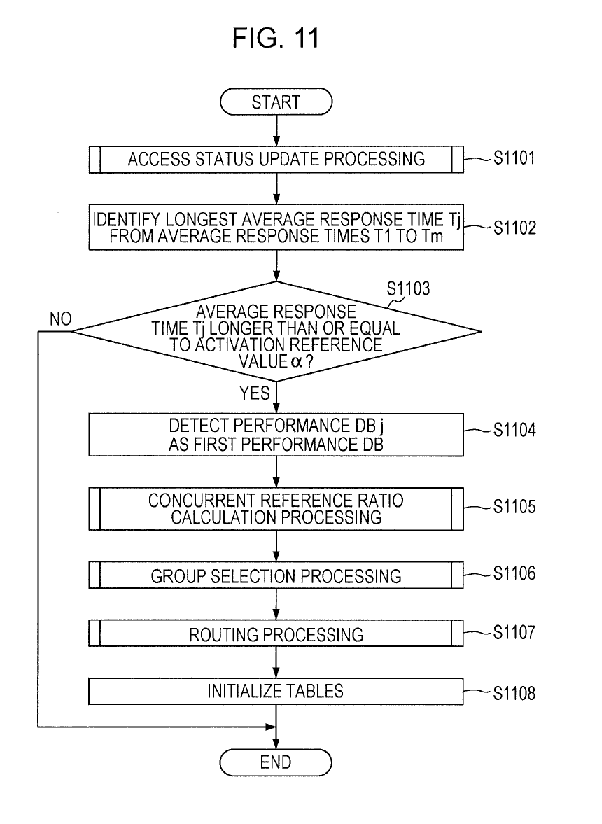

FIG. 11 is a diagram illustrating an example of an operational flowchart for data control processing executed by a data access control apparatus, according to a second embodiment.

In operation S1101, the first calculating unit 502 updates contents stored in the response management table 600 by performing access status update processing the detail of which will be described later.

In operation S1102, the detecting unit 503 references the response management table 600 and identifies the longest average response time Tj from among the average response times T1 to Tm of the performance databases 1 to m.

In operation S1103, the detecting unit 503 determines whether the identified average response time Tj is longer than or equal to the activation reference value α.

When the identified average response time Tj is longer than or equal to the activation reference value α (YES in operation S1103), the detecting unit 503 detects a performance database j as a first performance database (in operation S1104).

In operation S1105, the second calculating unit 506 calculates a concurrent reference ratio for each pair of mutually different agents by performing concurrent reference ratio calculation processing the detail of which will be described later.

In operation S1106, the identifying unit 507 selects a group Gs for which a storage destination database is to be changed by performing group selection processing the detail of which will be described later.

In operation S1107, the changing unit 505 changes a storage destination database of the performance data collected by an agent Ai included in the group Gs by performing routing processing the detail of which will be described later.

In operation S1108, the data access apparatus 100 initializes the response management table 600, concurrent reference count management table 800, and concurrent reference ratio management table 900, and then terminates a series of processing in this flowchart.

Meanwhile, when the identified average response time Tj is shorter than the activation reference value α (NO in operation S1103), the series of processing in this flowchart is terminated.

In this way, a storage destination database of performance data collected by an agent Ai of which the storage destination database has been set in the routing table 110 as a writing destination, may be changed from the first performance database to the second performance database.

(An Example of Access Status Update Processing)

An example of the access status update processing that is performed as operation S1101 of FIG. 11 will be described.

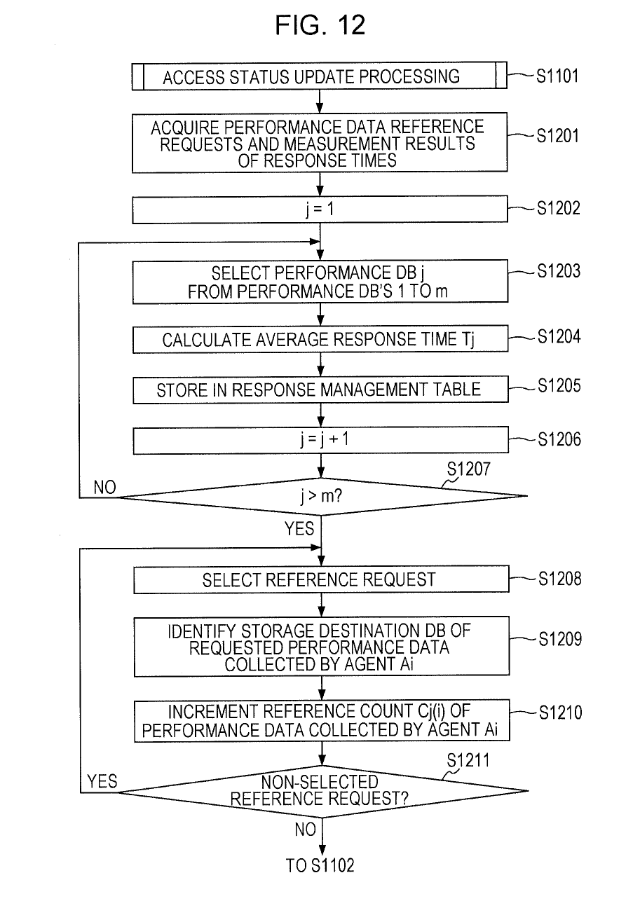

FIG. 12 is a diagram illustrating an example of an operational flowchart for access status update processing, according to an embodiment.

In operation S1201, the acquiring unit 501 acquires performance data reference requests and measurement results of response times taken to respond to the performance data reference requests.

Here, a performance data reference request means a reference request that is accepted from client terminal 201 during a predetermined time period X starting from a time point that is a fixed time previous to the current time and continuing to the current time. The measurement results of response times are obtained, for each performance database j, with respect to performance data reference requests that request for the performance data collected by an agent Ai and have been accepted during the predetermined time period X.

In operation S1202, the first calculating unit 502 sets variable j indicating a performance database j at “1”.

In operation S1203, the first calculating unit 502 selects a performance database j from among the performance databases 1 to m.

In operation S1204, the first calculating unit 502 calculates the average response time Tj of the performance database j from the measurement results of the response times of the performance database j for the performance data reference requests accepted during the predetermined time period X.

In operation S1205, the first calculating unit 502 stores the calculated average response time Tj of the performance database j in the response management table 600.

In operation S1206, the first calculating unit 502 increments variable j indicating the performance database j.

In operation S1207, the first calculating unit 502 determines whether variable j is greater than “m”.

When parameter j is not greater than “m” (NO in operation S1207), the processing returns to operation S1203. Meanwhile, when variable j is greater than “m” (YES in operation S1207), the first calculating unit 502 selects a reference request from among a set of performance data reference requests acquired during the predetermined time period X (in operation S1208).

In operation S1209, the first calculating unit 502 references the routing table 110 and identifies, based on the selected reference request, a storage destination database of the requested performance data collected by an agent Ai.

In operation S1210, the first calculating unit 502 increments the reference count Cj(i) of the performance data collected by the agent Ai, with respect to the identified storage destination database in the response management table 600.

In operation S1211, the first calculating unit 502 determines whether there exists a non-selected reference request left in the set of performance data reference requests accepted during the predetermined time period X. When there exists a non-selected reference request (YES in operation S1211), the processing returns to operation S1208. Meanwhile, when there exists no non-selected reference request left (NO in operation S1211), the processing proceeds to operation S1102 depicted in FIG. 11.

Thus, the reference count Cj(i) of each agent Ai and the average response time Tj may be updated for each performance database j.

(An Example of Concurrent Reference Ratio Calculation Processing)

Next, an example of concurrent reference ratio calculation processing performed as operation S1105 in FIG. 11 will be described.

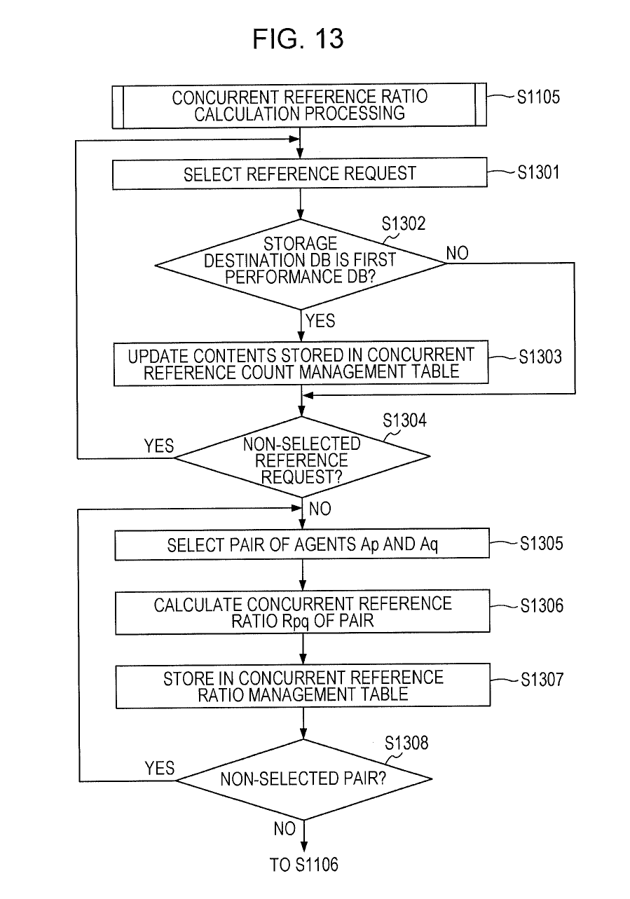

FIG. 13 is a diagram illustrating an example of an operational flowchart for concurrent reference ratio calculation processing, according to an embodiment.

In operation S1301, the second calculating unit 506 selects a reference request from among a set of performance data reference requests accepted during the predetermined time period X.

In operation S1302, the second calculating unit 506 determines whether the storage destination database identified by the selected reference request is the first performance database. When the identified storage destination database is not the first performance database (NO in operation S1302), the processing proceeds to operation S1304.

Meanwhile, when the identified storage destination database is the first performance database (YES in operation S1302), the second calculating unit 506 updates the contents stored in the concurrent reference count management table 800 in accordance with the agent name included in the selected reference request.

In operation S1304, the second calculating unit 506 determines whether there exists a non-selected reference request left in the set of performance data reference requests accepted during the predetermined time period X. When there exists a non-selected reference request left (YES in operation S1304), the processing returns to operation S1301.

Meanwhile, when there exists no non-selected reference request left (NO in operation S1304), the second calculating unit 506 selects a pair of agents Ap and Aq that are mutually different (in operation S1305).

In operation S1306, the second calculating unit 506 references the concurrent reference count management table 800 and calculates the concurrent reference ratio Rpq of the selected pair using equation (1) described above.

In operation S1307, the second calculating unit 506 stores the calculated concurrent reference ratio Rpq and concurrent reference ratio Pqp (Rpq=Rqp) of the pair in the concurrent reference ratio management table 900.

In operation S1308, the second calculating unit 506 determines whether there exists a non-selected pair of mutually different agents Ap and Aq left.

When there exists a non-selected pair left (YES in operation S1308), the processing returns to operation S1305. Meanwhile, when there exists no non-selected pair left (NO in operation S1308), the processing proceeds to operation S1106 depicted in FIG. 11.

In this way, the concurrent reference ratio of performance data collected by each pair of mutually different agents may be calculated for the first performance database.

(An Example of Group Selection Processing)

Next, the group selection processing performed as operation S1106 in FIG. 11 will be described.

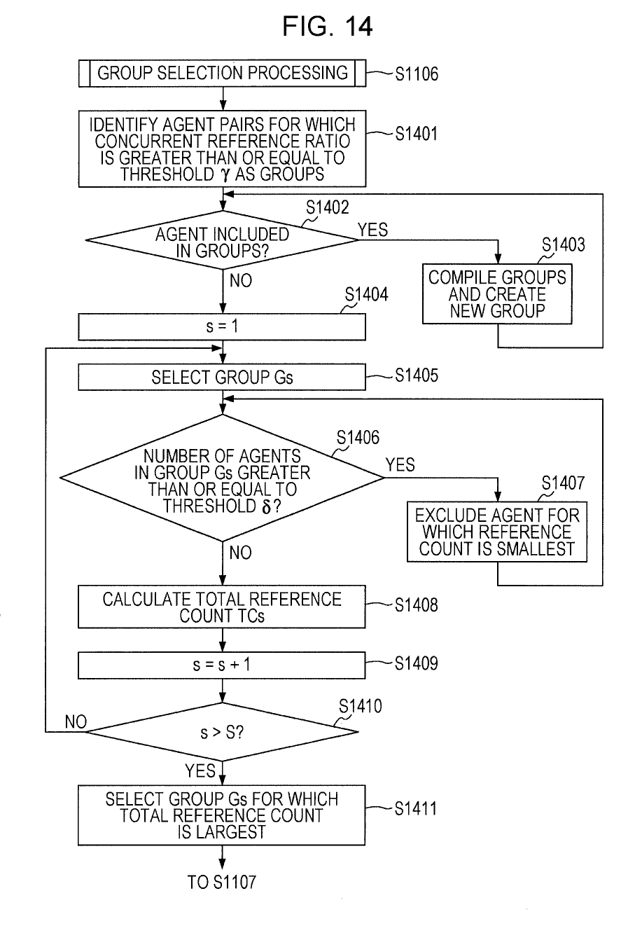

FIG. 14 is a diagram illustrating an example of an operational flowchart for group selection processing, according to an embodiment.

In operation S1401, the identifying unit 507 references the concurrent reference ratio management table 900 and identifies pairs of agents for which the concurrent reference ratio is greater than or equal to the threshold y, as groups, with respect to the first performance database.

In operation S1402, the identifying unit 507 determines whether there exists an agent Ai that is included in a plurality of groups. When there exists an agent Ai included in a plurality of groups (YES in operation S1402), the identifying unit 507 compiles the groups that include the same agent Ai and creates a new group (in operation S1403), and then the processing returns to operation S1402.

Hereinafter, the created groups will be expressed as “groups G1 to GS”, and an arbitrary group in the groups G1 to GS will be expressed as “a group Gs” (s=1, 2, . . . S).

Meanwhile, when there exists no agent Ai included in a plurality of groups in operation S1402 (NO in operation S1402), the identifying unit 507 sets variable s indicating the group Gs at “1” (in operation S1404).

In operation S1405, the identifying unit 507 selects a group Gs from among the groups G1 to GS.

In operation S1406, the identifying unit 507 determines whether the number of agents included in the selected group Gs is greater than or equal to the threshold value δ.

When the number of agents is greater than or equal to the threshold value δ (YES in operation S1406), the identifying unit 507 references the response management table 600 and excludes the agent, included in the group Gs, for which the reference count is smallest (in operation S1407), and then the processing returns to operation S1406.

Meanwhile, when the number of agents is smaller than the threshold value δ (NO in operation S1406), the identifying unit 507 references the response management table 600 and calculates the total reference count TCs by adding the reference counts corresponding to all agents included in the group Gs (in operation S1408).

In operation S1409, the identifying unit 507 increments variable s indicating the group Gs.

In operation S1410, the identifying unit 507 determines whether variable s is greater than the maximum group number S. When variable s is not greater than the maximum group number S (NO in operation S1410), the processing returns to operation S1405.

Meanwhile, when variable s is greater than the maximum group number S (YES in operation S1410), the identifying unit 507 selects, from among groups G1 to GS, the group Gs for which the total reference count TCs is largest (in operation S1411), an then the processing proceeds to operation S1107 depicted in FIG. 11.

As mentioned above, the group Gs corresponding to the largest total reference count TCs may be selected, from among groups G1 to GS each of which includes a pair of agents for which the concurrent reference ratio is greater than or equal to the threshold value γ, as the group for which the storage destination database is to be changed.

Although, in the above description, the group Gs having the largest total reference count TCs has been selected in operation S1411, a method for selecting the group for which the storage destination database is to be changed is not limited to this. For example, the identifying unit 507 may select sequentially M groups from among the groups G1 to GS, in descending order of a total reference count of a group, starting from the group having the maximum total reference count (for example, M may be set at two or three).

(An Example of Routing Processing)

Next, an example of routing processing performed as operation S1107 in FIG. 11 will be described.

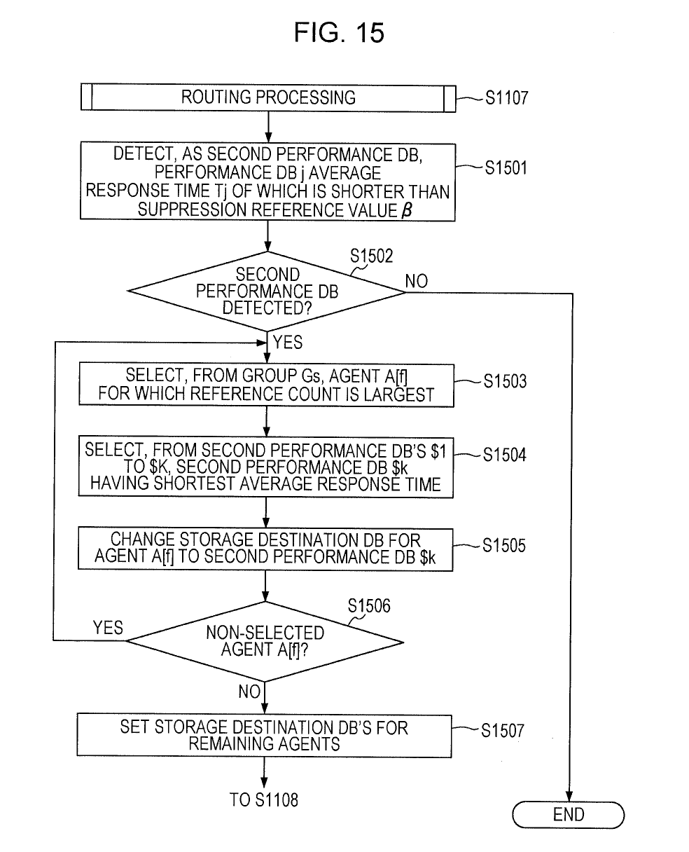

FIG. 15 is a diagram illustrating an example of an operational flowchart for routing processing, according to an embodiment.

In operation S1501, the detecting unit 503 references the response management table 600 and detects, from among the performance databases 1 to m, performance databases j the average response time Tj of which is shorter than the suppression reference value β, as a second performance database. Hereinafter, the performance databases j the average response time Tj of which is shorter than the suppression reference value β will be expressed as “second performance databases $1 to $K”.

In operation S1502, the selecting unit 504 determines whether the second performance databases $1 to $K have been detected. When the second performance databases $1 to $K have not been detected (NO in operation S1502), a series of processing in this flowchart is terminated. That is, since there is no performance database j having superior response performance, to which the storage destination database is to be changed, the data control processing by the data access apparatus 100 is terminated.

Meanwhile, when the second performance databases $1 to $K have been detected (YES in operation S1502), the processing proceeds to operation S1503.

In operation S1503, the selecting unit 504 references the response management table 600 and selects an agent A[f] for which the reference count is largest, from among the agents A[1] to A[F] included in the group Gs.

In operation S1504, the selecting unit 504 references the response management table 600 and selects a performance database $k having the shortest average response time from among the second performance databases $1 to $K.

In operation S1505, the changing unit 505 changes the storage destination database that has been set in the routing table 110 in association with the agent A[f], to the second performance database $k.

For example, the changing unit 505 creates new routing information in which the second performance database $k has been set, in the routing table 110, as the storage destination database for the agent A[f]. The storage start date and time in the new routing information is set, for example, at a date and time after a lapse of a predetermined (for example, one second) from the date and time at which the data control processing has been started.

In operation S1506, the selecting unit 504 determines whether there exists a non-selected agent A[f] left in the agents A[1] to A[F] included in the group Gs. When there exists a non-selected agent A[f] left (YES in operation S1506), the processing returns to operation S1503.

Meanwhile, when there exists no non-selected agent A[f] left (NO in operation S1506), the processing proceeds to operation S1507.

In operation S1507, the changing unit 505 selects, from among the agents A1 to An, agents for which a storage destination database has not been set yet, and sets storage destination databases for these selected agents in the new routing information, and then the processing proceeds to operation S1108 depicted in FIG. 11.

Thus, the agent A[f] may be sequentially selected from among the group Gs in descending order of a reference count, and a storage destination database for the selected agent A[f] may be changed to the performance database $k having the shortest average response time.

When a plurality of groups have been selected in operation S1411 in FIG. 14, processing in operations S1503 to S1506 above may be repeatedly performed for each of the plurality of groups.

As described above, the data access apparatus 100 according to the second embodiment may change the storage destination database of performance data collected by an agent Ai for which the storage destination database has been set in the routing table 110 as a writing destination, from the first performance database to the second performance database. Performance data that has been periodically collected by the agent Ai and has been written to the first performance data will be written to the second performance database in subsequent performance data collections, thereby suppressing an increase in the response time of the first performance database on which accesses due to reference requests from users concentrate.

Further, the data access apparatus 100 may detect performance databases j the average response time Tj of which is shorter than the suppression reference valueβ as a second performance database. Thus, pieces of performance data collected by the respective agents Ai may be distributed in different storage destination databases so that reference requests from users are leveled among the performance databases 1 to m. Accordingly, the unevenness of the number of reference requests per performance database may be suppressed and database resources may be efficiently utilized.

The data access apparatus 100 may also select, as an agent Ai for which the storage destination database is to be changed, the agent corresponding to the maximum number of references of performance data, from among agents for which the first performance database has been set as the storage destination database. Thus, performance data reference requests from users may be efficiently distributed among the performance databases 1 to m.

The data access apparatus 100 may also select, as an agent Ai for which the storage destination database is to be changed, one of a pair of mutually different agents having the largest concurrent reference ratio among a set of pairs each consisting of mutually different agents. Thus, performance data collected by the respective two agents that are frequently referenced at the same time are stored in different performance databases, thereby improving the response performance of performance databases j for reference requests from users.

Further, when a plurality of second performance databases are detected from the second performance databases $1 to $K, the data access apparatus 100 may change a storage destination database so that pierces of performance data collected by the agents included in the group Gs are stored in different storage destination databases. Thus, an increase in the response time of the first performance database may be reduced, and the response performance of performance databases j for reference requests from users may be improved by storing performance data collected by a plurality of agents and frequently referenced at the same time in different performance databases.

When a plurality of second performance databases are detected from the second performance databases $1 to $K, the data access apparatus 100 may also change a storage destination database to the performance database $k having the shortest average response time, by sequentially selecting the agent A[f], from the group Gs, in descending order of a reference count. Thus, performance data reference requests from users may be efficiently distributed among the performance databases 1 to m.

As mentioned above, the performance management system 200 according to the second embodiment may suppress a drop in response performance of a performance database j for reference requests from users, which would otherwise be caused by the unevenness of the number of reference requests per performance database. The performance management system 200 may also efficiently distribute performance data reference requests from many users, among the performance databases 1 to m. This enables database resources to be efficiently utilized, thereby lowering the operation cost.

Further, the performance management system 200 may adjust the activation reference value α and suppression reference value β to change the level of quality of service provided for users. As a result, by preparing a plurality of systems at different levels and setting different charges for them, service may be provided at a level appropriate for a price.

### Third Embodiment

A performance management system 1600 according to a third embodiment will be described. In the third embodiment, a computer different from the data access apparatus 100 collects performance data from the servers SV1 to SVn, writes the collected performance data, accepts reference requests from client terminals 201, and measures response times taken to respond to the reference requests. The descriptions for the same elements as in the first and second embodiment will be omitted here.

FIG. 16 is a diagram illustrating an example of a configuration of a performance management system, according to a third embodiment. In FIG. 16, the performance management system 1600 includes the data access apparatus 100, the servers SV1 to SVn, a plurality of client terminals 201, and a management server 1610. The data access apparatus 100, servers SV1 to SVn, plurality of client terminals 201, and management server 1610 in the performance management system 1600 are interconnected through the network 210 which is a wired or wireless network.

The management server 1610 is a computer configured to access the performance databases 1 to m, and to periodically collect performance data of the servers SV1 to SVn. For example, the management server 1610 receives performance data periodically collected by agents installed in the servers SV1 to SVn, from the servers SV1 to SVn. Thus, the performance data of the servers SV1 to SVn may be periodically collected.

The management server 1610 may be configured to write, into the performance databases 1 to m, the performance data collected from the servers SV1 to SVn. For example, the management server 1610 writes the performance data collected from the servers SV1 to SVn into performance databases that are set in the routing table 110 as writing destinations.

The management server 1610 may be configured to receive performance data reference requests from the client terminals 201 and to process them. The received performance data reference requests are stored in, for example, a storage unit in the management server 1610.

For example, the management server 1610 references routing table 110 and reads out the performance data identified by the accepted reference request from the performance database that is set as a writing destination of the identified performance data. The management server 1610 then sends the read-out performance data to the requesting client terminal 201.

The management server 1610 may be configured to measure a response time taken to respond to a reference request. The measurement result is stored, for example, in a storage unit of the management server 1610.

The servers SV1 to SVn may be each configured to send the performance data collected by the agents to the management server 1610. For example, each time performance data is collected, the servers SV1 to SVn send the performance data to the management server 1610. As a result, the performance data of the servers SV1 to SVn are periodically collected in the management server 1610.

When a user manipulates a client terminal 201 to make a performance data reference request, the client terminal 201 accepts the reference request. The client terminal 201 then sends the accepted reference request to the management server 1610. Thereafter, the client terminal 201 receives performance data from the management server 1610 and displays the received performance data on the display unit.

The data access apparatus 100 may be configured to control the management server 1610 so that the performance data of the servers SV1 to SVn, which are periodically collected, are written into the performance databases 1 to m. For example, the changing unit 505 of the data access apparatus 100 changes a storage destination database for an agent Ai, which has been set in the routing table 110 accessible from the management server 1610, from the first performance database to the second performance database.

It is also possible for the data access apparatus 100 to send a result of the change made by the changing unit 505 to the management server 1610. In this case, the management server 1610 changes a storage destination database for the agent Ai, which has been set in the routing table 110, from the first performance database to the second performance database, according to the result of the change which has been received from the data access apparatus 100.

As a result, performance data that has been periodically collected by the agent A2 and has been written to the performance database 1 will be written to the performance database 2 in subsequent performance data collections. Thus, it becomes possible to suppress an increase in the response time of the performance database 1 on which accesses due to reference requests from users are concentrated.

According to the third embodiment, since the management server 1610 is provided as a portal to the servers SV1 to SVn and the client terminals 201, the functions of the data access apparatus 100 may be simplified and the processing load thereof may be reduced as compared to the second embodiment.

The data control processing method described in the embodiments described above may be implemented by causing a computer, such as a personal computer or a workstation, to execute a program prepared in advance. The control program according to the embodiments may be recorded in a computer-readable recording medium, such as a hard disk, a flexible disk, a compact disc-read-only memory (CD-ROM), a magneto-optic (MO) disk, or a digital versatile disk (DVD). The control program is executed when it is read from the computer-readable recording medium by the computer. The control program may be distributed through the Internet or another network.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer readable recording medium having stored therein a program for causing a computer to execute a process, the computer included in a system including first and second storage devices, the first storage device storing first and second data, the second storage device storing the first data, the process comprising:
performing, on the first storage device, first access processing responsive to access requests to both of the first and second data; and
performing, on the second storage device, a second access processing responsive to an access request to the first data, upon receiving an access request to the first data after performing the first access processing.

2. The computer readable recording medium of claim 1, wherein the process further comprises:
measuring processing time for the first access processing performed on the first storage device; and
performing, on the second storage device, the second access processing responsive to an access request to the first data when the processing time obtained by the measuring after performing, on the first storage device, the first access processing responsive to access requests to both of the first and second data is longer than a predetermined time.

3. A computer readable recording medium having stored therein a program for causing a computer to execute a process, the computer writing target-status data characterizing a state of a monitoring target into a database that is set as a writing destination among a group of databases, the process comprising:
performing first database-detection processing to detect, from among the group of databases, a first database having a response-time index value that is greater than a first threshold value, the response-time index value indicating magnitude of a response time taken by a database to respond to a reference request; and
performing writing-destination change processing to change a writing destination of the target-status data characterizing a state of at least one monitoring target, for which the first database is currently set as a writing destination, from the first database to a second database included in the group of databases.

4. The computer readable recording medium of claim 3, wherein the process further includes performing second database-detection processing to detect, from among the group of databases, the second database having the response-time index value smaller than a second threshold value that is set at a value smaller than the first threshold value; and
the writing-destination change processing changes a writing destination of the target-status data characterizing a state of the at least one monitoring target, from the first database to the detected second database.

5. The computer readable recording medium of claim 3, wherein the process includes performing selection processing to select a first monitoring target from among one or more monitoring targets for which the first database is set as a writing destination, based on a first readout frequency indicating a frequency at which the target-status data characterizing a state of each of the one or more monitoring targets is read out from the first database; and
the writing-destination change processing changes a writing destination of the target-status data characterizing the selected first monitoring target, from the first database to the second database.

6. The computer readable recording medium of claim 5, wherein
the selection processing selects, as the first monitoring target, a monitoring target for which the first readout frequency of the target-status data is maximum among the one or more monitoring targets; and
under a condition that there exist a plurality of the second databases, the writing-destination change processing changes a writing destination of the target-status data characterizing the selected first monitoring target, from the first database to one of the plurality of the second databases that has the response-time value minimum among the plurality of the second databases.

7. The computer readable recording medium of claim 3, wherein the process further includes:
calculating, for each of pairs of monitoring targets, a second readout frequency at which two pieces of the target-status data characterizing respective monitoring targets included in the each pair of monitoring targets are simultaneously read out from the first database,
determining a first pair of monitoring targets of which the second readout frequency is greater than or equal to a second threshold value, based on the second readout frequency, and
selecting a first monitoring target included in the determined first pair of monitoring targets; and
the writing-destination change processing changes a writing destination of the target-status data characterizing a state of the selected first monitoring target, from the first database to the second database.

8. The computer readable recording medium of claim 7, wherein
under a condition that there exist a plurality of the second databases, the write-destination change processing changes a writing destination of the target-status data characterizing a state of each of the first pair of monitoring targets, from the first database to one of the plurality of second databases so that two writing destinations of the target-status data characterizing the first pair of monitoring targets are different from each other.

9. The computer readable recording medium of claim 3, wherein the process includes performing response-time calculation processing to calculate, as the response-time index value for each of the group of databases, an average value of response times of the each database; and
the first database-detection processing detects, from among the group of databases, the first database of which the average value of response times is greater than or equal to the first threshold value.

10. The computer readable recording medium of claim 3, wherein
under a condition that there exist a plurality of the second databases each having the response-time index value greater than or equal to the first threshold value, the first database-detection processing detects, as the first database, from among the group of databases, a database having the response-time index value that is maximum among the group of databases.

11. The computer readable recording medium of claim 3, wherein the process further including:
acquiring the target-status data characterizing a state of the at least one monitoring target after a writing destination of the target-status data characterizing a state of the at least one monitoring target has been changed to the second database; and
writing the acquired target-status data characterizing a state of the at least one monitoring target into the second database.

12. A computer readable recording medium having stored therein a program for causing a computer to execute a process, the computer controlling an information processing apparatus to write target-status data characterizing a state of a monitoring target into a database that is set as writing destinations among a group of databases, the process comprising:
detecting, from among the group of databases, a first database of which a response-time index value is greater than or equal to a predetermined threshold value, the response-time index value indicating magnitude of a response time of a database; and
changing a writing destination of the target-status data characterizing a state of at least one monitoring target for which the first database is set as a writing destination of the target-status data, from the first database to a second database included in the group of databases.

13. An apparatus comprising:
a processor to:
write target-status data characterizing a state of a monitoring target into a database that is set as writing destinations among a group of databases, detect, from among the group of databases, a first database of which a response-time value is greater than or equal to a predetermined threshold value, the response-time value indicating a length of a response time from issuing a request for reading out the data to receiving a response to the issued request; and
change a writing destination of the target-status data characterizing a state of at least one monitoring target for which the first database is set as a writing destination of the target-status data, from the first database to a second database included in the group of databases; and
a memory to store information on the writing destination of the target-status data.

14. An apparatus for controlling an information processing apparatus to write target-status data characterizing a state of a monitoring target into a database that is set as a writing destination among a group of databases, the apparatus comprising:
a detecting unit configured to detect, from among the group of databases, a first database of which a response-time value is greater than or equal to a predetermined threshold value, the response-time value indicating a length of a response time from issuing a request for reading out the data to receiving a response to the issued request; and
a changing unit configured to change a writing destination of the target-status data characterizing a state of at least one monitoring target for which the first database is set as a writing destination of the target-status data, from the first database to a second database included in the group of databases.

15. A method performed by a computer writing target-status data characterizing a state of a monitoring target into a database that is set as a writing destination among a group of databases, the method comprising:
detecting, from among the group of databases, a first database of which a response-time value is greater than or equal to a predetermined threshold value, the response-time value indicating a length of a response time from issuing a request for reading out the data to receiving a response to the issued request; and
changing a writing destination of the target-status data characterizing a state of at least one monitoring target for which the first database is set as a writing destination of the target-status data, from the first database to a second database included in the group of databases.

16. A method performed by a computer controlling an information processing apparatus to write target-status data characterizing a state of a monitoring target into a database that is set as writing destinations among a group of databases, the method comprising:
detecting, from among the group of databases, a first database of which a response-time value is greater than or equal to a predetermined threshold value, the response-time value indicating a length of a response time from issuing a request for reading out the data to receiving a response to the issued request; and
changing a writing destination of the target-status data characterizing a state of at least one monitoring target for which the first database is set as a writing destination of the target-status data, from the first database to a second database included in the group of databases.
